(19) United States
(12) Patent Application Publication
(10) Pub. No.: US 2004/0247860 A1
(43) Pub. Date: Dec. 9, 2004

(54) Polyethylene film that sinks in water and degrades in water and/or sunlight

(75) Inventor: Robert T. Bateman, Oroville, CA (US)

Correspondence Address: BURNS DOANE SWECKER & MATHIS L L P, POST OFFICE BOX 1404, ALEXANDRIA, VA, 22313-1404, US

(73) Assignee: Roplast Industries, Incorporated, Oroville, CA (US)

(21) Appl. No.: 10/819,036

(22) Filed: Apr. 5, 2004

Related U.S. Application Data
(60) Provisional application No. 60/460,468, filed on Apr. 3, 2003.

(51) Int. Cl. B32B 27/00

(52) U.S. Cl. 428/330; 428/500

(57) ABSTRACT

An improved polyethylene film, including: polyethylene; mixed with calcium carbonate; and a metal salt concentrate in the range of 20-25% calcium carbonate; and 5-10% metal salt concentrate. Optionally, starch may be mixed in the range of 5-10% starch.

### RELATED APPLICATION

The present invention claims the benefit of priority under 35 U.S.C Section 119 to U.S. Provisional Patent Application Ser. No. 60/460,468, entitled Polyethylene Film that Sinks in Water and Degrades in Water and/or Sunlight, filed Apr. 3, 2003.

### SUMMARY OF THE INVENTION

The present invention provides an improved polyethylene film, including: (a) polyethylene; mixed with (b) calcium carbonate; and (c) a metal salt concentrate. Optionally, starch may also be mixed with the polyethylene. In an exemplary embodiment of the invention, the polyethylene is mixed with the calcium carbonate and metal salt concentrate in the following ranges: 20-25% calcium carbonate; and 5-10% metal salt concentrate. When starch is optionally added, it may be mixed with the polyethylene in the following preferred range: 5-10% starch.

Advantages of the present improved polyethylene film invention include that it may degrade in water and/or sunlight and may sink in water. As such, an advantage of this improved polyethylene film is that it addresses the hitherto unsolved problem of controlling the increasing amount of floating plastic litter in rivers and seas. This problem is coming to the forefront of environmental concerns.

### DETAILED DESCRIPTION OF THE INVENTION

In accordance with the present invention, the improved polyethylene film is produced by mixing and extruding polyethylene with calcium carbonate and metal salt concentrate (and optionally starch as well).

In preferred aspects of this invention, the range of the proportions of these three additives are as follows: 20-25% calcium carbonate; 5-10% starch and 5-10% metal salt concentrate.

What is claimed is:

1. An improved polyethylene film, comprising:
(a) polyethylene; mixed with
(b) calcium carbonate; and
(c) a metal salt concentrate.

2. The improved polyethylene film of claim 1, further comprising:
starch mixed into the polyethylene film.

3. The improved polyethylene film of claim 1, wherein the polyethylene is mixed with the calcium carbonate and metal salt concentrate in the following preferred ranges:
20-25% calcium carbonate; and
5-10% metal salt concentrate.

4. The improved polyethylene film of claim 2, wherein the polyethylene is mixed with the starch in the following preferred range:
5-10% starch.

5. The improved polyethylene film of claim 1, wherein the polyethylene film sinks in water.

6. The improved polyethylene film of claim 1, wherein the polyethylene film degrades in water.

7. The improved polyethylene film of claim 1, wherein the polyethylene film degrades in sunlight.

8. A method of making a polyethylene film, comprising:
mixing and extruding polyethylene with calcium carbonate and metal salt concentrate.

9. The method of claim 8, further comprising:
mixing starch with the polyethylene

10. The method of claim 8, wherein the polyethylene is mixed with calcium carbonate and metal salt concentrate in the following preferred ranges:
20-25% calcium carbonate; and
5-10% metal salt concentrate.

11. The method of claim 9, wherein the polyethylene is mixed with the starch in the following preferred range:
5-10% starch.
